(19) United States
(12) Patent Application Publication
(10) Pub. No.: US 2015/0377190 A1
(43) Pub. Date: Dec. 31, 2015

(54) MOTOR VEHICLE AND AIR FILTER BOX

(71) Applicant: FORD GLOBAL TECHNOLOGIES, LLC, Dearborn, MI (US)

(72) Inventors: Vanco Smiljanovski, Bedburg (DE); Helmut Matthias Kindl, Aachen (DE); Joerg Kemmerling, Monschau (DE); Jens Dunstheimer, Koln (DE); Andreas Kuske, Geulle (DE); Franz Arnd Sommerhoff, Aachen (DE); Ludwig Stump, Koeln (DE)

(21) Appl. No.: 14/727,043

(22) Filed: Jun. 1, 2015

(30) Foreign Application Priority Data
Jun. 30, 2014 (DE) 102014212606.1

(51) Int. Cl. F02M 35/024; F02M 35/02; F02M 35/16; F02M 35/10

(52) U.S. Cl. CPC F02M 35/024; F02M 35/10222; F02M 35/0201; F02M 35/10262; F02M 35/161

(57) ABSTRACT

A motor vehicle is provided which has an engine, an inlet air section for supplying the engine with inlet air, a compressor arranged in the inlet air section and a vortex generator arranged in the inlet air section upstream of the compressor. The vortex generator has at least one guide vane for generating a vortex in the inlet air and a vortex generator outlet having a first radius. The compressor has a compressor inlet having a second radius, which is smaller than the first radius. According to the invention, an exhaust gas recirculation line opens downstream of the vortex generator outlet and upstream of the compressor inlet.

### TECHNICAL FIELD

The present invention relates to a motor vehicle having an engine, an inlet air section, a compressor arranged in the inlet air section and a vortex generator arranged in the inlet air section upstream of the compressor. Moreover, the invention relates to an air filter box in which the vortex generator is arranged.

### BACKGROUND

In the prior art, an inlet system for a combustion engine is known from DE 102009046522 A1. The inlet system comprises an inlet manifold for delivering air to the combustion engine, a radial compressor having a pump element, which is mounted in a pump casing so as to rotate about an axis, an inlet opening in the casing, through which gas is delivered to the pump element, an outlet opening in the casing, through which gas at elevated pressure is delivered to the inlet manifold, an inlet duct, which is connected to the inlet opening so as to deliver air to the radial compressor, and a flow management device having a number of fixed, radially extending vanes, which are arranged in the inlet duct upstream of the inlet opening in order to impart a swirling motion to the gas entering through the inlet opening. In this case, the inlet duct has a tapering section which extends in the direction of the inlet opening, with the result that the cross-sectional area of the inlet duct decreases with decreasing distance from the inlet opening. The flow management device is arranged at a distance upstream of the inlet opening, with the result that the effective area of flow through the flow management device is greater than it would be if the flow management device were arranged adjacent to the inlet opening and greater than a minimum value so as to prevent excessive backpressure at high gas flow rates.

### SUMMARY

It is the underlying object of the present invention to provide a motor vehicle and an air filter box in which inlet air flows to the compressor in an improved manner.

This object is achieved by means of a motor vehicle and by an air filter box as claimed. Advantageous developments of the invention are described in the description.

The motor vehicle according to the invention comprises an engine, an inlet air section for supplying the engine with inlet air, a compressor arranged in the inlet air section and a vortex generator arranged in the inlet air section upstream of the compressor. The vortex generator has at least one guide vane for generating a vortex in the inlet air and a vortex generator outlet having a first radius. The compressor has a compressor inlet having a second radius, which is smaller than the first radius. According to the invention, an exhaust gas recirculation line opens downstream of the vortex generator outlet and upstream of the compressor inlet.

It is thereby advantageously made possible to produce a vortex in the inlet air, which improves the approach flow to the compressor, or to rotor blades of the compressor. At the same time, the swirling flow produces good mixing of fresh air with the recirculated exhaust gas. The vortex generation enables the operating range of the compressor to be widened. At the same time, vortex generation with little loss is possible with the configuration proposed.

In particular as part of a turbocharger, the compressor of the motor vehicle is connected for torque transmission to an exhaust turbine positioned in an exhaust section of the motor vehicle. In an advantageous embodiment of the motor vehicle, the exhaust gas recirculation line is a low-pressure exhaust gas recirculation line. In the case of such a line, exhaust gas produced during the operation of the engine is removed downstream of the exhaust turbine and fed back to the inlet section.

Low-pressure exhaust gas recirculation has the advantage that the entire flow of exhaust gas the exhaust turbine and the entire enthalpy of the exhaust gas are used. This leads to engine operation with better performance and improved fuel efficiency. Moreover, nitrogen oxide emissions can be reduced. The advantages of the vortex generator are thereby combined with the advantages of low-pressure exhaust gas recirculation.

In another advantageous embodiment of the motor vehicle, the motor vehicle comprises an air filter box. In particular, the vortex generator is arranged in the air filter box.

As a result, no additional space is taken up for the vortex generator in the engine compartment. Moreover, the air filter box and the vortex generator can be embodied as one subassembly, simplifying assembly of the motor vehicle.

In another advantageous embodiment of the motor vehicle, the vortex generator is arranged axially. In this case, the axial arrangement is designed in such a way that the inlet air can flow into the vortex generator substantially along a center line of the inlet air section.

The axial arrangement can be implemented with a relatively small circumference.

As an alternative to axial arrangement, the vortex generator can also be arranged radially. In this case, the radial arrangement is designed in such a way that the inlet air can flow into the vortex generator substantially radially with respect to the center line.

Radial arrangement can be implemented with a relatively short length. Moreover, it allows higher entry rates than axial arrangement. In addition, radial arrangement allows generation of a more powerful vortex. Radial arrangement also offers the advantage that an adjusting device, which the motor vehicle can have in addition in order to adjust the at least one guide vane of the vortex generator, can be embodied in a more compact and therefore more space-saving way and can be positioned more easily.

The adjustability of the at least one guide vane makes it possible to generate the vortex in various configurations. Here, it is possible, in particular, to adjust the at least one guide vane in accordance with an operating variable of the engine. In particular, the guide vane can thereby be adjusted in accordance with the speed or the load of the engine.

Adaptation of the swirling flow to the prevailing operating states of the engine is thereby made possible. The motor vehicle can be operated more efficiently.

The air filter box according to the invention for a motor vehicle which comprises an engine requiring inlet air for its operation is designed to accommodate a filter element for filtering inlet air. According to the invention, the air filter box comprises a vortex generator having at least one guide vane for generating a vortex in inlet air flowing through the vortex generator.

Thus, a subassembly is provided into which the vortex generator is integrated in addition to the conventional air filter element. Retrofitting in the case of motor vehicles, especially those with pressure-charged engines, is thus also made possible, whereby the retrofitted motor vehicle can obtain the abovementioned advantages of the motor vehicle according to the invention.

In particular, the vortex generator is arranged axially in the air filter box. With the axial arrangement, the air filter box is designed in such a way that the inlet air can flow into the vortex generator substantially along a center line of the air filter box. As an alternative, the vortex generator is arranged radially in the air filter box. In this case, the air filter box is designed in such a way that the inlet air can flow into the vortex generator substantially radially with respect to the center line.

Two different embodiments, which can be used according to the requirements of the respective type of motor vehicle, are thus provided.

In another advantageous embodiment of the air filter box, the at least one guide vane is adjustable. In particular, the air filter box has an adjusting device for this purpose which can be connected to an engine control unit of the motor vehicle.

The action of the vortex generator can thus be adapted to various operating states of the engine.

### BRIEF DESCRIPTION OF THE DRAWING FIGURES

Illustrative embodiments of the invention are explained in greater detail by means of the drawings and the following description. In the drawings:

FIG. 1 shows a motor vehicle according to the invention in an illustrative embodiment.

FIG. 2 shows an inlet air section of the motor vehicle with an air filter box according to the invention in a first illustrative embodiment.

FIG. 3 shows the inlet air section with the air filter box in a second illustrative embodiment.

### DETAILED DESCRIPTION

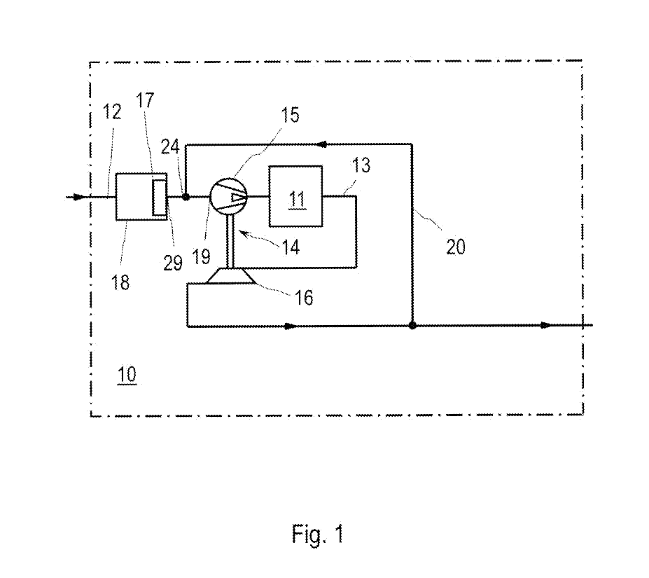

In FIG. 1, the motor vehicle 10 according to the invention is shown in an illustrative embodiment in a diagram. The motor vehicle 10 has an engine 11, which is an internal combustion engine.

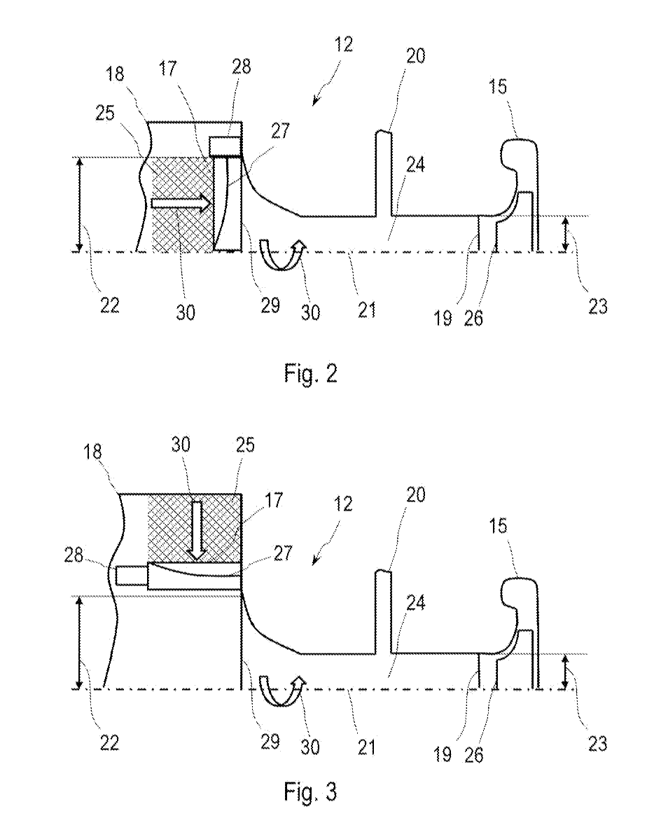

The motor vehicle 10 furthermore comprises an inlet air section 12. In FIGS. 2 and 3, the inlet air section 12 is in each case shown in an illustrative embodiment. The inlet air section 12 is designed to carry inlet air 30 required for operation of the engine 11 to the engine 11. In this case, the inlet air 30 can be fresh air from the environment of the motor vehicle 10 or a mixture of fresh air and recirculated exhaust gas, which is formed during the operation of the engine 11. To carry away the exhaust gas, the motor vehicle 10 has an exhaust section 13.

Moreover, the motor vehicle 10 comprises a compressor 15. In particular, the compressor 15 is part of a turbocharger 14 and is connected for torque transmission to an exhaust turbine 16 arranged in the exhaust section 13. The turbocharger 14 is designed in a known manner to be driven by the exhaust gas passed through the exhaust section 13 and to produce a boost pressure in the inlet air section 12 by means of the compressor 15. For this purpose, the compressor 15 is provided with compressor blades 26, which are rotor blades.

The motor vehicle 10 is furthermore equipped with a vortex generator 17. The vortex generator 17 is arranged upstream of the compressor 15. The vortex generator 17 is designed to impart a swirl to the inlet air 30. A motion component in a circumferential direction is thereby imparted to the flowing inlet air 30. As a result, the inlet air 30 flows helically in the direction of the compressor 15 downstream of the vortex generator 17.

In particular, the vortex generator 17 is arranged in an air filter box 18 according to the invention. The air filter box 18 is designed to accommodate a filter element 25 for filtering the inlet air 30. The vortex generator 17 has at least one guide vane 27. In one possible embodiment, the vortex generator 17 has a guide vane cascade comprising a plurality of guide vanes 27.

The at least one guide vane 27 is, in particular, embodied so as to be adjustable. For this purpose, the vortex generator 17 can comprise an adjusting device 28. The adjusting device 28 can be connected, in particular, to an engine control unit. Adjustment of the at least one guide vane 27 in accordance with an engine operating variable, in particular the engine speed and/or engine load, can thereby be accomplished.

The vortex generator 17 can be designed to receive the inlet air 30 axially in relation to a center line 21 or, alternatively, to receive the inlet air 30 radially in relation to the center line 21. The axial embodiment is illustrated in FIG. 2 and the radial embodiment is illustrated in FIG. 3. The inlet air 30 is preferably discharged with a swirl around the center line 21.

The vortex generator 17 is dimensioned in the motor vehicle 10 in such a way that a first radius 22 of a vortex generator outlet 27 is larger than a second radius 23 of a compressor inlet 19. Here, the first radius 22 is larger than the second radius 23. A vortex is intensified by the decreasing radius and can thus be generated with relatively low losses in the larger first radius 22.

The motor vehicle 10 according to the invention has an exhaust gas recirculation line 20. This diverts at least some of the exhaust gas from the exhaust section 13, in particular downstream of the exhaust turbine 16, and carries the diverted exhaust gas into the inlet air section 12. In the motor vehicle 10 according to the invention, a mixing point 24, at which the exhaust gas recirculation line 20 opens, is provided downstream of the vortex generator outlet 29 and upstream of the compressor inlet 19. Recirculated exhaust gas is thereby also affected by the vortex and the inlet air 30 is well mixed.

What is claimed:

1. A motor vehicle comprising an engine, an inlet air section for supplying the engine with inlet air, a compressor arranged in the inlet air section and a vortex generator arranged in the inlet air section upstream of the compressor, wherein the vortex generator has at least one guide vane for generating a vortex in the inlet air and a vortex generator outlet having a first radius, and wherein the compressor has a compressor inlet having a second radius, which is smaller than the first radius, wherein an exhaust gas recirculation line opens downstream of the vortex generator outlet and upstream of the compressor inlet.

2. The motor vehicle as claimed in claim 1, wherein the exhaust gas recirculation line is a low-pressure exhaust gas recirculation line.

3. The motor vehicle as claimed in claim 1, wherein the motor vehicle has an air filter box and the vortex generator is arranged in the air filter box.

4. The motor vehicle as claimed in claim 3, wherein the vortex generator is arranged axially.

5. The motor vehicle as claimed in claim 3, wherein the vortex generator is arranged radially.

6. The motor vehicle as claimed in claim 3, wherein the at least one guide vane is adjustable.

7. The motor vehicle as claimed in claim 6, wherein the at least one guide vane is adjusted in accordance with an operating variable of the engine.

8. The motor vehicle of claim 1, wherein the vortex generator is arranged axially.

9. The motor vehicle of claim 1, wherein the vortex generator is arranged radially.

10. The motor vehicle of claim 1, wherein the at least one guide vane is adjustable.

11. The motor vehicle of claim 10, wherein the at least one guide vane is adjusted in accordance with an operating variable of the engine.

12. An air filter box for a motor vehicle, that includes an engine that requires inlet air for its operation, wherein the air filter box is designed to accommodate a filter element for filtering inlet air, wherein the air filter box comprises a vortex generator having at least one guide vane for generating a vortex in inlet air flowing through the vortex generator.

13. The air filter box as claimed in claim 12, wherein the vortex generator is arranged axially in the air filter box.

14. The air filter box as claimed in claim 12, wherein the vortex generator is arranged radially in the air filter box.

15. The air filter box as claimed in claim 12, wherein the at least one guide vane is adjustable.

16. The air filter box as claimed in claim 13, wherein the at least one guide vane is adjustable.

17. The air filter box as claimed in claim 14, wherein the at least one guide vane is adjustable.
